(19) United States
(12) Patent Application Publication
(10) Pub. No.: US 2010/0182684 A1
(43) Pub. Date: Jul. 22, 2010

(54) Altazimuth mount variable rate tracking control

(76) Inventor: James D. Burr, Evergreen, CO (US)

Correspondence Address: SCOTT L. TERRELL PC, 12970 W. 20TH AVE, GOLDEN, CO, 80401, US

(21) Appl. No.: 12/590,959

(22) Filed: Nov. 17, 2009

Related U.S. Application Data
(60) Provisional application No. 61/199,542, filed on Nov. 18, 2008.

(51) Int. Cl. G02B 23/00; G02B 23/16

(52) U.S. Cl. 359/429

(57) ABSTRACT

An altazimuth and elevation tracking control for adjusting the azimuth and elevation on an altazimuth telescope mount is provided. The tracking control has an azimuth motor drive assembly which includes a tension mounting plate, a wire spring member, and at least two capstan driving motors for rotating a circumferential edge of the ground board of the telescope mount. As elevation tracking control assembly may be provided which includes a motor drive assembly having a horizontal mounting bracket for attachment to a vertical sidewall of the telescope mount including outwardly extending flanges, each including a plain bearing, a longitudinally extending spiral drive bar has a first end rotatably connected to the first flange plain bearing and a second end, and a drive motor having a coupling shaft. The drive motor is connected to the mounting bracket so that the coupling shaft extends inwardly through the second flange plain bearing in axial alignment with the drive bar. An adjustable slider is interference fit to the drive bar so that the slider is engaged for travel along the extent between the first and second ends of the drive bar as the drive bar rotates when operated by the drive motor. A connecting rod has a slider connecting end and a cranking end. The connecting end is rotatably connected to the slider. A clutch assembly has a clutch plate which includes an inner and an outer surface. The inner surface is designed for attachment to the elevation hub, and the outer surface has a threaded lug positioned at a centroid of the clutch plate for connecting the cranking end to the clutch plate with a lug nut. A variable speed control and power source operates the drive motors.

### CROSS REFERENCE TO RELATED APPLICATIONS

Pursuant to 35 U.S.C. 119(e), applicant claims the benefit of U.S. Ser. No. 61/199,542, filed on Nov. 18, 2008, pursuant to 35 U.S.C. 111(b).

### BACKGROUND OF THE INVENTION

1. Field of the Invention

The present invention relates to altazimuth telescope mounts. In particular, it relates to an altazimuth variable rate motor control for tracking objects across the sky with a telescope.

2. Description of the Related Art

Most ground based telescopes were traditionally mounted on equatorial mounts. With such mounts, the equatorial axis (ascension axis) is paired with a second perpendicular axis of rotation (declination axis). Equatorial mounts have long since been equipped with motor drives for automatic tracking of objects across the sky. However, equatorial mounts are characteristically cumbersome and heavy, and hence expensive. Today, altazimuth designs have gained in popularity over the use of expensive equatorial mounts because of their simplicity in design, but use two axes of rotation which are necessary to compensate for the diurnal motion of the Earth, and are often computer controlled with expensive microprocessor control assemblies to coordinate the two axes of rotation.

The altazimuth mount is a simple two-axis mount for supporting and rotating a telescope about two mutually perpendicular axes (a vertical altitude axis, and a horizontal azimuth axis). When used with an astronomical telescope, the biggest advantage of an altazimuth mount lies in its simplicity of mechanical design. Indeed, John Dobson popularized this simplified mount design for use with his Newtonian reflectors because they were so easy to construct, of non-machined and readily available materials, such as plywood and hardware, of materials which could be found in any local hardware store.

However, unlike equatorial mounts, the primary disadvantage with the altazimuth mount lies in its inability to follow astronomical objects in the night sky, as the Earth spins on its axis, the way that an equatorial mount does. Equatorial mounts need only to be rotated about a single axis, at a constant rate, in order to follow the rotation of the night sky (diurnal motion). On the other hand, altazimuth mounts need to be rotated about both axes, each at a variable rate, and they also impart a rotation to the field of view. Thus, hobbyists and professionals alike have since migrated toward the use of a microprocessor based, two-axis drive systems, together with digital setting circle data, in order to eliminate some of these disadvantages.

While the foregoing computer controlled two-axis drive systems, together with the use of digital setting circle data, offer some utility, a major disadvantage in such systems lies in the fact that, like equatorial mounts, they are cumbersome, heavy and expensive. Microprocessor based systems are also difficult to set up, at night, in the field. Thus, it is desirable to provide an azimuth and elevation tracking control for adjusting the azimuth and elevation on an altazimuth telescope mount which is suitable for retrofit application, easy to install and operate, light in weight, inexpensive, and easily transported and setup in the field. The present invention satisfies these needs.

### BRIEF SUMMARY OF THE INVENTION

It is therefore an object of the present invention to provide an azimuth and elevation tracking control for adjusting the azimuth and elevation on a altazimuth telescope mount.

It is another object of the present invention to provide an azimuth and elevation tracking control for adjusting the azimuth and elevation on an altazimuth telescope mount which is easily installed for retrofit application, on an existing altazimuth telescope mount.

It is another object of the present invention to provide an azimuth and elevation tracking control for adjusting the azimuth and elevation on an altazimuth telescope mount which is light in weight, low in cost and easily transportable.

It is yet another object of the present invention to provide a friction slide azimuth tracking control for adjusting the azimuth on an altazimuth telescope mount which may be operated either by hand or with a motor control without a need for repositioning the tracking control assembly.

To overcome the problems of the prior art methods and in accordance with the purpose of the invention, as embodied and broadly described herein, briefly an altazimuth and elevation tracking control is provided for adjusting the azimuth and/or elevation on a altazimuth telescope mount. The tracking control has an azimuth motor drive assembly including a tension mounting plate, a wire spring member, and at least two capstan driving motors for rotating a circumferential edge of the altazimuth mount ground board. An elevation tracking control includes a motor drive assembly. The motor drive assembly has a horizontal mounting bracket for attachment to a vertical sidewall of the telescope mount and has outwardly extending flanges, each with a plain bearing, a longitudinally extending spiral drive bar having a first end rotatably connected to the first flange plain bearing and a second end. A drive motor has a coupling shaft. The drive motor is connected to the mounting bracket so that the coupling shaft extends inwardly through the second flange plain bearing in axial alignment with the drive bar. An adjustable slider is interference fit to the drive bar so that the slider is engaged for travel along the extent between the first and second ends of the drive bar as the drive bar rotates when operated by the drive motor. A connecting rod has a slider connecting end and a cranking end. The connecting end is rotatably connected to the slider. A clutch assembly has a clutch plate including an inner and an outer surface, the inner surface is designed for attachment to the elevation hub, of the telescope, and the outer surface has a threaded lug positioned at a centroid of the clutch plate for connecting the cranking end to the clutch plate with a lug nut. A power source and variable speed control powers and operates the drive motors.

Additional advantages of the present invention will be set forth in part in the description that follows and in part will be obvious from that description or can be learned from practice of the invention. The advantages of the invention can be realized and obtained by the apparatus particularly pointed out in the appended claims.

### BRIEF DESCRIPTION OF THE SEVERAL VIEWS OF THE DRAWINGS

The accompanying drawings, which are incorporated in and which constitute a part of the specification illustrate at least one embodiment of the invention and, together with the description, explain the principles of the invention.

FIG. 1 is a perspective view of the present invention used to control a Dobsonian type telescope altazimuth rocker box mount.

FIG. 2 is a perspective view of the azimuth adjusting motor assembly spring loaded mounting plate, spring member, and the v azimuth adjusting motors.

FIG. 3 is a top sectional view, through section 3 of FIG. 1, showing the preferred position of the azimuth adjusting motor drive assembly, elevation control assembly, battery, motor controller, in relation to the rocker box.

FIG. 4 is a top view of the azimuth adjusting motor drive assembly spring loaded mounting plate, wire spring, and the azimuth adjusting motors with the wire spring in a fully compressed tolerance position.

FIG. 5 is a side view of the elevation motor drive assembly showing the relative operational positions of the telescope barrel, when the connecting rod linear motion is transferred to rotational motion, for adjusting the elevation with the slider engaged on the drive bar when operated by the drive motor.

FIG. 5 is a top view of a preferred embodiment for the motor controller showing the preferred embodiment of switches for operation of the present invention.

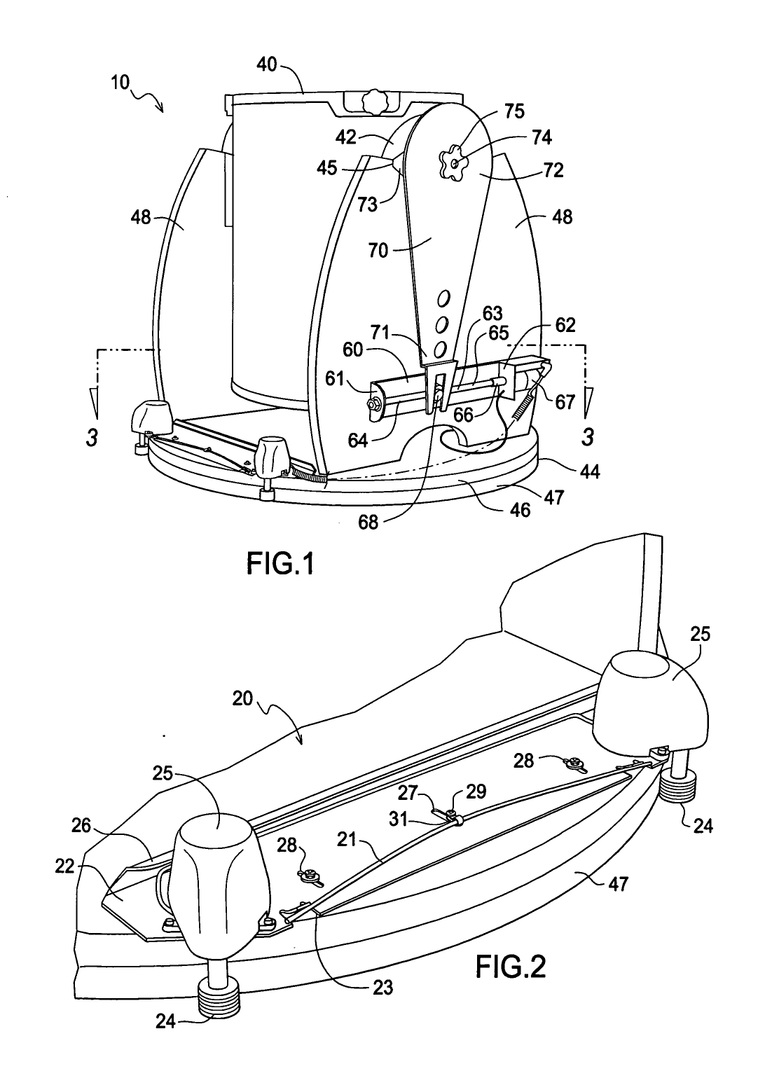

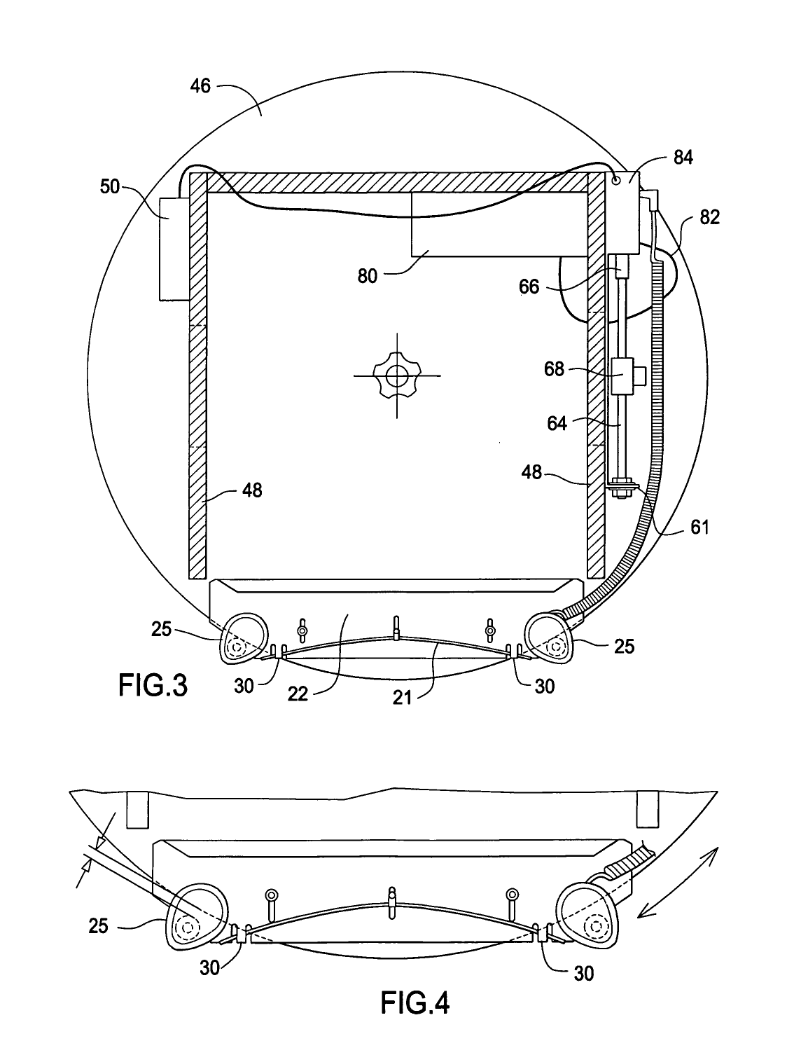

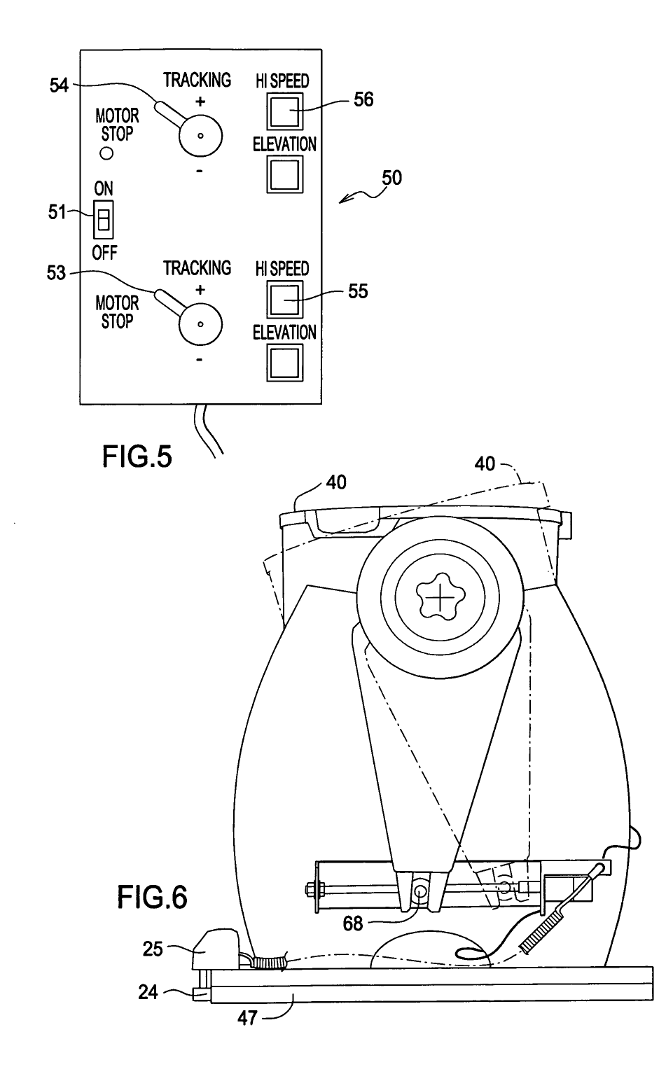

### DETAILED DESCRIPTION OF THE INVENTION

Unless specifically defined otherwise, all technical or scientific terms used herein have the same meaning as commonly understood by one of ordinary skill in the art to which this invention belongs.

Although any of the methods and materials similar or equivalent to those described herein can be used in the practice or testing of the present invention, the preferred methods and materials are now described. Reference will now be made in detail to the presently preferred embodiments of the invention, examples of which are illustrated in the accompanying drawings wherein like numerals represent like features of the invention.

Referring now to the drawing figures, the preferred embodiment of the altazimuth and elevation tracking control 10 for adjusting the azimuth and elevation on a altazimuth telescope 40, in accordance with the present invention, is shown. The tracking control 10 is useful for installation on a ground based altazimuth telescope mount. Altazimuth telescope mounts are typically constructed of a ridged ground board 44, having a predetermined thickness defining a circumferential edge 47 portions, supporting a rotating disc 46 rocker box. The rocker box uses a rotating disc 46 and at least two opposing vertically extending side walls 48. The rotating disc 46 is pivotally connected to the ground board 44, and each of the vertically extending side walls 48 generally include a semicircular upper bearing void 45, or rocker portion, for pivotally attaching a telescope cylindrical elevation hub 42 mount. The bearing void 45 is typically lined with a material, such as felt, so that the elevation hub 42 easily rotates along an axis which is perpendicular to the vertically extending side walls 48. Such altazimuth telescope mounts are commonly used on Dobsonian type reflector telescope designs which are well known to both hobbyists and professionals alike. Examples of such designs include models known as the LIGHTBRIDGE™, by Meade Corporation, the SKY-WATCHER™. Such telescopes are typically marketed in apertures sizes which fall in the range of 76 mm-406 mm. Larger models are particularly suited for use with the present invention, and are commonly found in sizes having an aperture of 203 mm, 254 mm, 305 mm, and even 406 mm.

Azimuth control is accomplished with the azimuth motor drive assembly 20. The assembly 20 has a tension mounting plate 22, a wire spring member 21 including pinned ends 23, and at least two capstan 24 driving motors 25. The mounting plate 22 desirably includes a lip 26 along its length for grasping by hand in order to adjust the mounting plate 22 tension in relation to the ground board 44 circumferential edge 47. The mounting plate b is designed with a middle portion, having a central clear slot 27, and end portions each having lateral clear slots 28. The clear slots 27, 28 are designed, as such, in order to attach the mounting plate 22 to the upper surface of the rotating disc 46. The clear slots 27, 28 thereby allow the mounting plate 22 to slide, in an inward and outward direction, with respect to the outer edge 47 of the ground board 44. The mounting plate 22 is attached to the rotating disc 46 with loosely tightened screws 29, such as a #4 wood screw. In this manner, as a very desirable feature of the present invention, it is important to note that the mounting plate 22, being spring 21 loaded, provides for an even frictional bias of the capstan drives 24 against the circumferential edge 47 of the ground board 44 so that the disc may be rotated either by hand or with the motor controller 50 without any adjustment to the position of the mounting plate 22 or motors 25, after initial installation. The capstan drives 24 preferably include a rubber tire fitted to the outer circumference of the capstan drive cylinder in order to impart a frictional bias against the circumferential edge 47 of the ground board 44.

A wire spring member 21, such as piano wire, is connected at its ends to the pinned end connectors 30 of the mounting bracket 22 and buckled, in a compressed state, through attachment of the middle portion of the wire spring 21 at a position which is proximate to the central clear slot 27, either by the wood screw or a plastic clip 31. In this manner, the wire spring 21 imposes a frictional tension between the motor driven capstans 24 and the edge 47 of the ground board 44 for driving the rotating disc 46 in a clockwise or counterclockwise direction. Thus, in use, and in accordance with a unique advantage of the present invention, the disc 46 may be rotated either by hand for course adjustments in azimuth or with the motor controller 50 for fine adjustment without adjusting the position of the bracket 22 once it has been installed. The lateral clear slots 28 are also cut into the bracket 22 for lateral alignment of the bracket 22 when attached to the rotating disc 46 with screws 29.

The mounting bracket 22 also serves as the motor mount for attaching the capstan drive 24 motors 25 to the bracket 22 with one each positioned at either end. The capstan driving motors 25 are mounted to the motor mounts so that the capstan drives 24 extend downwardly for imparting a friction tension against the circumferential edge 47 of the ground board 44. The operational drive ratio of the drive motors 25 in relationship to circumference of the rotating disc 46, is desirably in the range of (15,000 rpm-30,500 rpm) to 1 rpm, respectively, and more desirably at a predetermined ratio of 22,500 rpm to 1 rpm.

In order to accomplish altitude control, an elevation motor drive assembly is provided. The elevation assembly has a horizontal mounting bracket 60 with outwardly extending flanged ends 61, 62. The bracket 60 is attached to a vertical sidewall 48 of the telescope rocker box. The flanged ends 61, 62 desirably include clear holes which serve as plain bearings. A longitudinally extending spiral drive bar 63, or rod, member, such as an externally threaded rod, has a first end 64 which is rotatably connected to the first flange plain bearing, and a second end 65 which is connected to the elevation drive motor coupling 66. The motor coupling 66 connects the second end 65 of the bar 63 to the motor 67 shaft. In turn, the drive motor 67 is connected to the mounting bracket 60 so that the coupling 66 shaft extends inwardly through the second flange plain bearing, and in axial alignment with the second end of the drive bar 63 so that the coupling 66 shaft and the drive bar 63 second end 62 are connected for axial rotation of the drive bar 63 in relation to the mounting bracket 60.

An adjustable slider 68 is interference fit to the drive bar 63 so that the slider 68 is engaged for travel along the extent between the first 64 and second 62 ends of the drive bar 63 as the drive bar 63 rotates, when operated by the drive motor 67. The slider 68 is preferably cylindrical in shape in order to facilitate rotational coupling with the connecting rod 70 fork end 71. In the preferred embodiment, the slider 68 is spring loaded for engagement with the drive bar 63 so that it may be freely reset, by hand, along the full extent of the first 64 and second 62 ends of the drive bar 63. In this manner the operator may make a course reset alignment, from time-to-time, in order to reset the relative position of the slider 68 along the extent of the drive bar so that the connecting rod 70 does not run out of travel. A button on the slider 68 is then released in order to engage the slider 68 with the drive bar 63 for use in motor controlled operation. The slider 68 is rotationally connected to the connecting rod 70. The connecting rod 70 has a fork shaped slider connecting end 71, and a cranking end 72. The cranking end 72 is deployed for cranking the cylindrical elevation hub when attached to the barrel of the telescope 40.

A clutch assembly is used for frictional engagement of the cranking end 72 of the connecting rod 70 to the elevation hub 42 of the telescope. The clutch assembly is designed with a clutch plate 73, preferably a triangular shaped metal plate (not shown), having an inner and an outer surface. The inner surface is frictionally attached to the elevation hub 42 and the outer surface has a threaded lug 74 positioned at a centroid of the clutch plate 73. The cranking end 72 of the connecting rod 70 is attached to the clutch plate 73 with a fender washer and lug nut 75 fastener assembly. The lug nut 75 is desirably a thumb screw for operation by hand. In the preferred embodiment, the inner surface of the clutch plate 73 attaches to the elevation hub 42 with three Allen button head screws which are positioned equidistant around the periphery of the clutch plate 73. The button head screws are tightened so as to avoid any slippage. In the preferred embodiment, a roller bracket plate (not shown) is also attached, which is shaped to conform to the semicircular void in the upper surface of the rocker box, to the vertically extending side walls 48 for receiving the telescope hub 42. The bracket plate include roller bearing arrangement where the rollers bear against the telescope hub 42 in order to facilitate a smooth rotation of the telescope hub 42 within the rocker portion 45 of the rocker box.

Because Altazimuth mounts are much different than equatorial mounts, which require only one motor to track the stars, each of the altazimuth mounts must be driven and motor speed must vary when observing different regions of the sky. With the motor controller 50 the operator can, with a little practice, train the motors to follow an object. However, different parts of the sky will require a change, either in the motor speed or direction. For example, elevation reverses when the operator goes over the zenith. In addition, another advantage with the present invention allows the operator to electrically move the scope without any vibration to thereby keep the object having an appearance of floating in space.

Referring now to FIG. 6, the altitude and elevation are controlled with a motor control electrical switch box. The controller 50 has an on/off slider switch 51 for switching power to the unit. For each axis, a potentiometer 53, 54, or “pot”, is included, as an adjustable voltage divider, for positional control of the respective tracking motors with relative settings including a “stop”, forward (+), or reverse (−) tracking orientations in order to change relative motor speed and to reverse the motors. In this manner the operator is able to “track and train” the motors to follow an object. While the operator is learning to set the correct motor speed, he/she will undoubtedly see the object, to be observed, drifting off to one edge of the field of view. In that event, the operator simply hits one of the high speed buttons 55, 56 in order to return it, to the field of view center, without affecting the previously determined motor speed setting. The altazimuth can also be controlled simply by using only the high speed buttons 55, 56. As a result, with the present invention, the movement is so smooth that one rarely observes any difficulty in over-shooting, as one often experiences when moving an altazimuth mount, by hand. In the preferred embodiment, the high speed buttons 55, 56 are approximately six to eight times that of the tracking speed.

The tracking system 10 is powered with a 12 volt rechargeable battery 80. The battery 80 is preferably mounted inside of the rocker box with hook and loop fasteners. A suitable battery 80 provides about twelve hours of tracking time before one experience a need for recharging the battery 80. In the preferred embodiment, the battery cable 82 is attached to a junction box, preferably mounted to the elevation horizontal mounting bracket 60, including electrical connection jacks for the motor controller, battery charge input, and azimuth motors circuits.

While the present invention has been described in connection with the embodiments as described and illustrated above, it will be appreciated and understood by one of ordinary skill in the art that modifications may be made in the tracking assembly, in accordance with the present invention, without departing from the true spirit and scope of the invention as described and claimed herein.

I claim:

1. An azimuth tracking control for adjusting the azimuth on a altazimuth telescope mount having a ground board including a circumferential edge and a rotating rocker box including a rotating disc base and at least two opposing vertically extending side walls, the rotating disc base pivotally connected to the ground board, and each of the vertically extending side walls including a semicircular upper rocker bearing void for pivotally attaching a telescope cylindrical elevation hub, said tracking control, comprising:
(a) an azimuth motor drive assembly having a tension mounting plate, a wire spring member including pinned ends, and at least two capstan driving motors, the mounting plate including a middle portion having a central clear slot and end portions each having a lateral clear slot, a pinned end connector, and a motor mount, wherein the tension spring pinned ends are attached to the pinned end connectors so that the tension spring is compressed when attached to the disc base at the central clear slot, and the capstan driving motors are mounted to the motor mounts so that the capstan drives extend downwardly for imparting a friction tension against the circumferential edge of the ground board; and
(b) a power source and a variable speed motor control connected to the capstan driving motors.

2. The tracking control according to claim 1, wherein the motor and the rotating disc circumference have a ratio in the range of (15,000-30,500 rpm) to 1 rpm, respectively.

3. The tracking control according to claim 1, wherein the tension spring is a piano wire.

4. The tracking control according to claim 1, wherein the power source is a battery.

5. An altazimuth and elevation tracking control for adjusting the azimuth and elevation on a altazimuth telescope mount having a ground board having a circumferential edge and a rotating rocker box including a rotating disc base and at least two opposing vertically extending side walls, the rotating disc base pivotally connected to the ground board, and each of the vertically extending side walls including a semicircular upper rocker bearing void for pivotally attaching a telescope cylindrical elevation hub, said tracking control, comprising:
(a) an azimuth motor drive assembly having a tension mounting plate, a wire spring member including pinned ends, and at least two capstan driving motors, the mounting plate including a middle portion having a central clear slot and end portions each having a lateral clear slot, a pinned end connector, and a motor mount, wherein the tension spring pinned ends are attached to the pinned end connectors so that the tension spring is compressed when attached to the disc base at the central clear slot, and the capstan driving motors are mounted to the motor mounts so that the capstan drives extend downwardly for imparting a friction tension against the circumferential edge of the ground board;
(b) an elevation motor drive assembly having a horizontal mounting bracket for attachment to a vertical sidewall of the telescope mount including a first and a second outwardly extending flange, each including a plain bearing, a longitudinally extending spiral drive bar having a first end rotatably connected to the first flange plain bearing and a second end, and a drive motor having a coupling shaft, the drive motor connected to the mounting bracket so that the coupling shaft extends inwardly through the second flange plain bearing in axial alignment with the drive bar second end so that the coupling shaft and the drive bar second end are connected for axial rotation in relation to the mounting bracket;
(c) an adjustable slider interference fit to the drive bar so that the slider is engaged for travel along the extent between the first and second ends of the drive bar as the drive bar rotates when operated by the drive motor;
(d) a connecting rod having a slider connecting end and a cranking end, the connecting end is rotatably connected to the slider;
(e) a clutch assembly having a clutch plate including an inner and an outer surface, the inner surface attached to the elevation hub and the outer surface having a threaded lug positioned at a centroid of the clutch plate for connecting the cranking end to the clutch plate with a lug nut; and
(f) a power source and variable speed control connected to the capstan and elevation driving motors.

6. The tracking control according to claim 5, wherein the motor and the rotating disc circumference have a ratio in the range of (15,000-30,500 rpm) to 1 rpm, respectively.

7. The tracking control according to claim 5, wherein the tension spring is a piano wire.

8. The tracking control according to claim 5, wherein the power source is a battery.

9. In combination with a altazimuth telescope mount having a ground board including a circumferential edge and a rotating rocker box including a rotating disc base and at least two opposing vertically extending side walls, the rotating disc base pivotally connected to the ground board, and each of the vertically extending side walls including a semicircular upper rocker bearing void for pivotally attaching a telescope cylindrical elevation hub, an azimuth tracking control for adjusting the azimuth on the altazimuth telescope mount, comprising:
(a) an azimuth motor drive assembly having a tension mounting plate, a wire spring member including pinned ends, and at least two capstan driving motors, the mounting plate including a middle portion having a central clear slot and end portions each having a lateral clear slot, a pinned end connector, and a motor mount, wherein the tension spring pinned ends are attached to the pinned end connectors so that the tension spring is compressed when attached to the disc base at the central clear slot, and the capstan driving motors are mounted to the motor mounts so that the capstan drives extend downwardly for imparting a friction tension against the circumferential edge of the ground board; and
(b) a power source and a variable speed motor control connected to the capstan driving motors.

10. The tracking control according to claim 9, wherein the motor and the rotating disc circumference have a ratio in the range of (15,000-30,500 rpm) to 1 rpm, respectively.

11. The tracking control according to claim 9, wherein the tension spring is a piano wire.

12. The tracking control according to claim 9, wherein the power source is a battery.
